(19) United States
(12) Patent Application Publication
(10) Pub. No.: US 2020/0076971 A1
(43) Pub. Date: Mar. 5, 2020

(54) INFORMATION PROCESSING APPARATUS ALLOWING DATA COMMUNICATION WITH IMAGE FORMING APPARATUS, CONTROL METHOD THEREFOR, AND APPLICATION DEVELOPMENT ENVIRONMENT PROVIDING SYSTEM

(71) Applicant: CANON KABUSHIKI KAISHA, Tokyo (JP)

(72) Inventor: Tsuyoshi Itami, Tokyo (JP)

(21) Appl. No.: 16/529,894

(22) Filed: Aug. 2, 2019

(30) Foreign Application Priority Data
Aug. 30, 2018 (JP) 2018-161687

(51) Int. Cl. H04N 1/00

(52) U.S. Cl. CPC H04N 1/00488; H04N 1/0049; H04N 1/0048; H04N 1/00477; H04N 1/00482

(57) ABSTRACT

An information processing apparatus that is capable of reading information aloud when the information about an image forming apparatus changes. A memory that stores a set of instructions. A processor that executes the set of instructions to detect that one of display components that constitute an operation screen provided by an application running on the information processing apparatus has been dynamically changed, execute a set of instructions that constitutes the application that causes control for changing attribute information about a dynamic content associated with the changed display component by the processor, receive a fact that the display component has been dynamically changed and the attribute information showing the changed content of the dynamic content from the application using an operating system in response to the execution, and output voice guidance with a screen reader according to the attribute information received using the operating system.

### BACKGROUND OF THE INVENTION

### Field of the Invention

The present invention relates to an information processing apparatus allowing data communication with an image forming apparatus, a control method therefore, and an application development environment providing system.

### Description of the Related Art

A high-performance mobile terminal like a smart phone has spread in recent years. An information processing apparatus like such a mobile terminal runs an operating system program (OS program) and runs a print application program (print AP program) that the information processing apparatus makes the image forming apparatus print on the OS program. The information processing apparatus that runs the print AP program retrieves available image forming apparatuses through data communication like wireless communication, displays the retrieved apparatuses, and select an image forming apparatus to be used according to an operation from among the displayed apparatuses.

Moreover, the information processing apparatus selects a file according to a user's operation from among saved files, generates print data from the selected file, and sends the print data to the selected image forming apparatus. Thereby, the image forming apparatus receives the print data from the information processing apparatus through data communication and prints the print data according to a setting content of the print data.

Incidentally, Japanese Laid-Open Patent Publication (Kokai) No. 2009-157696 (JP 2009-157696A) discloses a technique that an information processing apparatus displays a status of an image forming apparatus obtained from the image forming apparatus and reads the status aloud. When the status of the image forming apparatus is read aloud, a visually impaired person is able to grasp the status of the image forming apparatus.

When the information processing apparatus is running the print AP program together with the OS program as mentioned above, for example, a voice guidance function of the information processing apparatus is managed by the OS program of the information processing apparatus. The print AP program merely requires the voice guidance function to read aloud under control of the OS program, and is not always able to call the voice guidance function of the information processing apparatus directly.

The information processing apparatus requires a user to do a display-switching operation to an operation unit in order to read the status of the image forming apparatus aloud using the voice guidance function. Even if data communication with the image forming apparatus is available, the information processing apparatus has to update a displayed content according to the operation to the operation unit, for example, in order to read the status of the image forming apparatus obtained by the data communication aloud. When the image forming apparatus continues to read the latest status of the image forming apparatus aloud, a user has to continue operating the operation unit. As mentioned above, an image forming apparatus that enables data communication with an image forming apparatus is required to read a status or information aloud without requiring an user's operation when the status of the image forming apparatus or the information about an available image forming apparatus changes. Moreover, such a requirement exists not only in a case of reading a status of an image forming apparatus aloud, but also in a case of retrieving image forming apparatuses that is usable by an information processing apparatus.

### SUMMARY OF THE INVENTION

One aspect of the present invention provides a technique that enables to read information aloud when the information about an image forming apparatus changes. Moreover, another aspect of the present invention provides a technique that improves convenience of voice guidance of an information processing apparatus.

Accordingly, a first aspect of the present invention provides an information processing apparatus including at least one memory that stores a set of instructions, and at least one processor that executes the set of instructions to detect that one of display components that constitute an operation screen provided by an application running on the information processing apparatus has been dynamically changed, execute a set of instructions that constitutes the application that causes control for changing attribute information about a dynamic content associated with the changed display component by the at least one processor, receive a fact that the display component has been dynamically changed and the attribute information showing the changed content of the dynamic content from the application using an operating system in response to the execution, and output voice guidance with a screen reader according to the attribute information received using the operating system.

Accordingly, a second aspect of the present invention provides an application development environment providing system including a layout editor that is able to arrange a first-type display component, a code editor that receives input of a program code, and a compiler that compiles the program code. An instance corresponding to the first-type display component arranged using the layout editor includes at least a first accessibility attribute that shows a description of the display component and a second accessibility attribute showing that a content shown by the display component is changed. And, the compiler compiles a program code that changes the second accessibility attribute of the instance into a set of instructions that sends a fact that the display component has been dynamically changed together with information showing a changed content of the content to an operating system.

Accordingly, a third aspect of the present invention provides a control method for an information processing apparatus that is communicable with an image forming apparatus, the control method including obtaining information relevant to the image forming apparatus, executing a change process that changes metadata used for voice guidance in a case where it is determined that information that should be reported to a user among information about the image forming apparatus has been changed according to the obtained information, and reading the changed information about the image forming apparatus aloud with a voice guidance function in response to the execution of the change process.

According to the one aspect of the present invention, the image forming apparatus that enables data communication with an image forming apparatus is able to read a status or information aloud without requiring an user's operation when the status of the image forming apparatus or the information about an available image forming apparatus changes. Moreover, according to the other aspect of the present invention, convenience of voice guidance in an information processing apparatus is improved.

Further features of the present invention will become apparent from the following description of exemplary embodiments with reference to the attached drawings.

### BRIEF DESCRIPTION OF THE DRAWINGS

FIG. 1 is an explanatory view showing an example of an information processing system according embodiments of the present invention.

FIG. 2 is an explanatory view showing an example of a hardware configuration of an image forming apparatus in FIG. 1.

FIG. 3 is an explanatory view showing an example of a hardware configuration of an information processing apparatus in FIG. 1.

FIG. 4 is an explanatory view showing examples of functions of a controller achieved in the information processing apparatus by software.

FIG. 5A, FIG. 5B, and FIG. 5C are explanatory views showing examples of screens displayed by a print application program on the information processing apparatus in FIG. 1.

FIG. 6 is a flowchart showing a process for displaying a status of the image forming apparatus under printing on the information processing apparatus in a first embodiment of the present invention.

FIG. 7A, FIG. 7B, and FIG. 7C are explanatory views showing examples of screens displaying a status of the image forming apparatus under printing displayed on the information processing apparatus in FIG. 1.

FIG. 8 is a flowchart showing a process for displaying a status of the image forming apparatus under scanning on the information processing apparatus in a second embodiment of the present invention.

FIG. 9A, FIG. 9B, and FIG. 9C are explanatory views showing examples of screens displaying a status of the image forming apparatus under scanning displayed on the information processing apparatus.

FIG. 10 is a flowchart showing a process for retrieving and displaying an image forming apparatus in a third embodiment of the present invention.

FIG. 11A, FIG. 11B, and FIG. 11C are explanatory views showing examples of screens displayed on the information processing apparatus during retrieval of an image forming apparatus.

FIG. 12A, FIG. 12B, and FIG. 12C are explanatory views showing display UI components of the information processing apparatus in a fourth embodiment of the present invention.

### DESCRIPTION OF THE EMBODIMENTS

Hereafter, embodiments according to the present invention will be described in detail by referring to the drawings. Configurations described in the following embodiments are only examples, and the scope of the present invention is not limited by the configurations described in the embodiments.

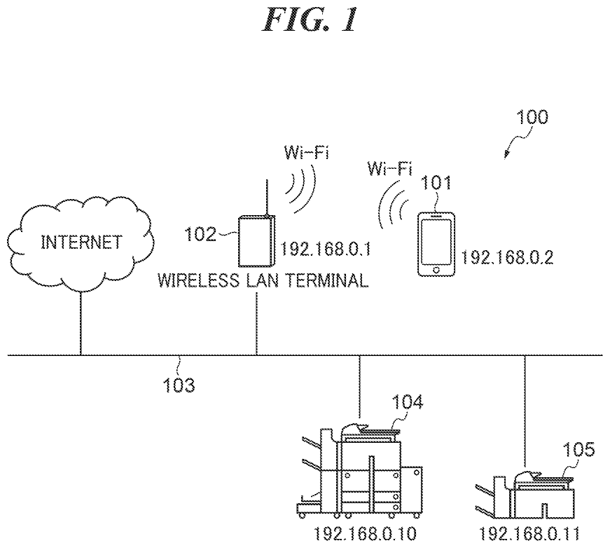

FIG. 1 is an explanatory view showing an information processing system 100 according embodiments of the present invention. The information processing system 100 in FIG. 1 has a mobile information processing apparatus 101, a plurality of image forming apparatuses 104 and 105, a wireless LAN terminal 102, and a LAN 103. The image forming apparatus 104 is provided with a printer function, a copy function, a scanner function, and a facsimile transmission function, for example.

The wireless LAN terminal 102 is a main device of a wireless LAN that has a general network router function. The wireless LAN terminal 102 provides the wireless LAN based on the IEEE802.11 standard specification etc. The image forming apparatus 104 and the wireless LAN terminal 102 are connected to the LAN 103. The LAN 103 may be connected to the Internet. The mobile information processing apparatus 101 is a computer that is used by a user who instructs to send a print job to the image forming apparatus 104.

When entering into a wireless LAN area that the wireless LAN terminal 102 provides, the mobile information processing apparatus 101 performs wireless communication with the wireless LAN terminal 102. Thereby, the mobile information processing apparatus 101 automatically joins in the LAN 103 using preset authentication information and enables communication with each of the image forming apparatuses 104 and 105.

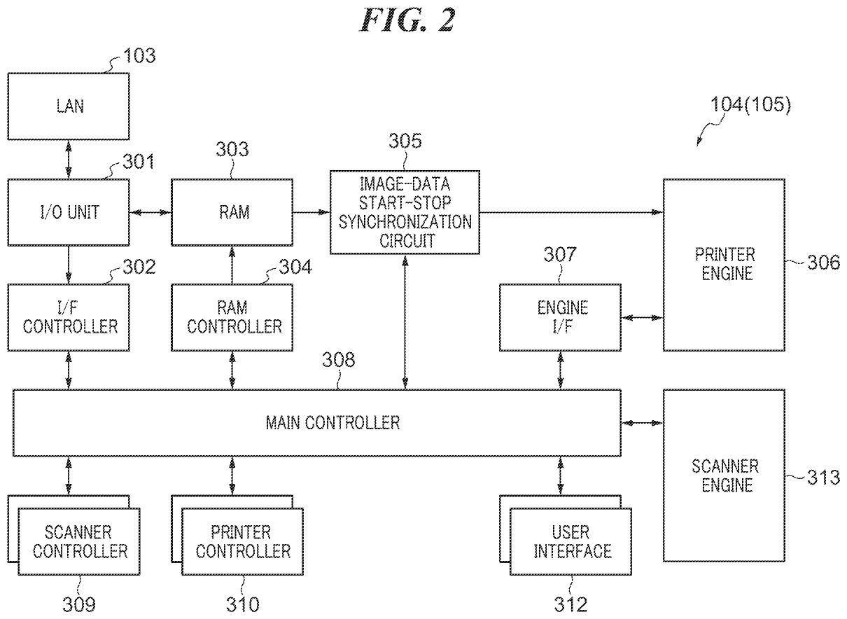

FIG. 2 is an explanatory view showing an example of a hardware configuration of the image forming apparatus 104 in FIG. 1. The configuration of the image forming apparatus 105 is also identical. The image forming apparatus 104 in FIG. 2 is a multifunction apparatus (an MFP (Multi-Function Peripheral)) that has a scanner function and a printer function. The image forming apparatus 104 in FIG. 2 has a main controller 308. An IF controller 302, a RAM controller 304, an image-data start-stop synchronization circuit 305, an engine I/F 307, and a scanner controller 309 are connected to the main controller 308. Moreover, a printer controller 310, a user interface 312, and a scanner engine 313 are connected to the main controller 308.

The main controller 308 controls actions of the entire image forming apparatus 104. The main controller 308 is an essential module of control and performs a process for suitably allocating control commands received from the information processing apparatus 101 through an I/O unit (input/output unit) 301 to the scanner controller 309 and the printer controller 310. The main controller 308 controls the printer engine 306 and the scanner engine 313 in response to instructions from each controller and the user interface 312. The I/O unit 301 is connected to a communication means, such as the LAN 103. The I/O unit 301 performs data communication with the information processing apparatus 101 through the LAN 103.

It should be noted that the image forming apparatus 104 may have a plurality of I/O units 301. The I/F controller 302 controls the I/O unit 301. The RAM 303 is a primary storage unit. The RAM 303 stores external data, such as control commands obtained by the I/O unit 301, and image data read with the scanner engine 313, for example. The RAM 303 stores image data developed by the printer controller 310 before sending it to the printer engine 306, for example. The RAM controller 304 manages allocation of the RAM 303.

The printer controller 310 converts PDL data that is a print job received from the information processing apparatus 101 into an internal execution command including development image data etc. that the main controller 308 is able to interpret in the RAM 303. The main controller 308 executes various kinds of control to the printer engine 306 through the engine I/F 307 according to the internal execution command in the RAM 303. The image-data start-stop synchronization circuit 305 outputs image data, which is taken with the printer controller 310 or the scanner engine 313 and is developed to the RAM 303, to the printer engine 306 in synchronization with actions of the printer engine 306.

The printer engine 306 prints the image data in the RAM 303 onto an output medium, such as a paper sheet. The scanner controller 309 converts a scanning control command received from the information processing apparatus 101 into an internal execution command that the main controller 308 is able to interpret in the RAM 303. The main controller 308 executes various kinds of control to the scanner engine 313 according to the internal execution command in the RAM 303. The scanner engine 313 reads image data. The scanner controller 309 generates a scanning control command including the read image data in the RAM 303.

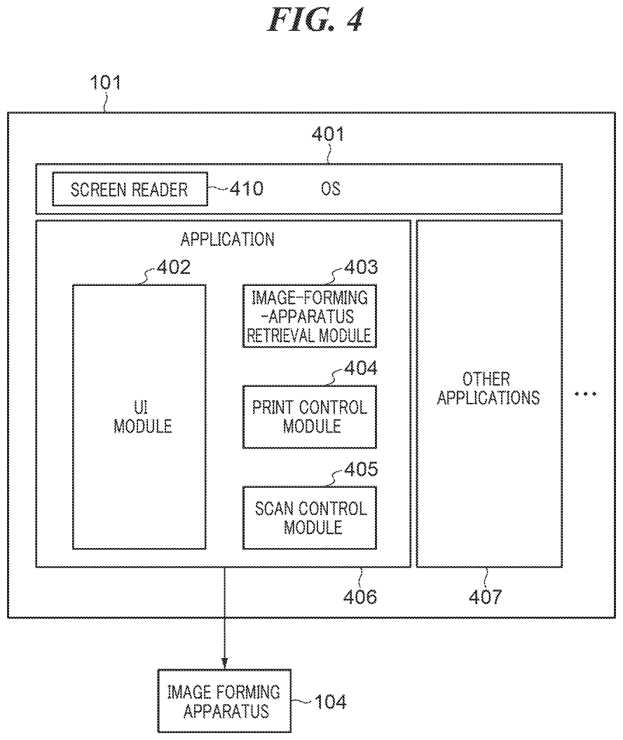

A high-performance mobile terminal like a smart phone has spread in recent years. Accordingly, it is requested that the mobile information processing apparatus 101 can be used also in the information processing system 100. The mobile information processing apparatus 101 runs an operating system program (OS program) and runs a print application program (print AP program) 406 (see FIG. 4) that the information processing apparatus makes the image forming apparatus print on the OS program.

The information processing apparatus 101 that runs the AP program 406 retrieves the available image forming apparatuses 104 and 105 through data communication like wireless communication, displays the retrieved apparatuses, and selects the image forming apparatus 104 to be used from among the displayed apparatuses according to an operation to the display. Moreover, the information processing apparatus 101 selects a file from among saved files according to a user's operation, generates print data from the selected file, and sends the print data to the selected image forming apparatus 104. Thereby, the image forming apparatus 104 receives the print data from the information processing apparatus 101 through data communication and prints the print data according to a setting content of the print data.

Incidentally, the mobile information processing apparatus 101 is used by a single user. Accordingly, when the mobile information processing apparatus 101 reads a status of the image forming apparatus 104 aloud, a visually impaired person is able to grasp the status of the image forming apparatus 104 easily. This improves the convenience of the information processing system 100 by a visually impaired person.

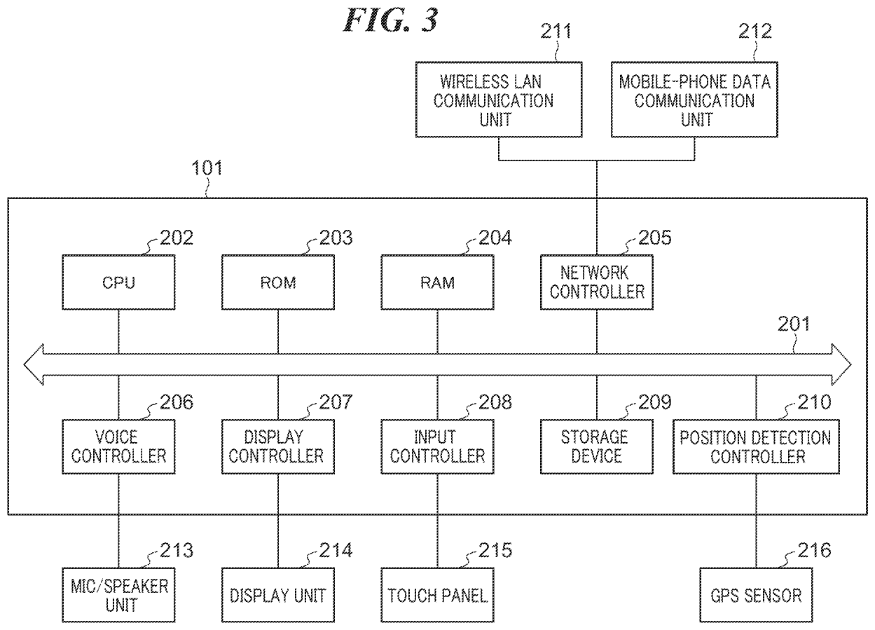

FIG. 3 is an explanatory view showing an example of a hardware configuration of the information processing apparatus 101 in FIG. 1. The information processing apparatus 101 in FIG. 3 is a mobile terminal or a smart phone, and may be running an OS program for a compact terminal, and programs that control telephone call and data communication. It should be noted that the information processing apparatuses 101 may be a personal computer that is not provided with a position detecting controller 210, GPS sensor 216, mobile-phone data communication unit 212, etc. that are mentioned later.

The information processing apparatus 101 in FIG. 3 has a wireless LAN communication unit 211, the mobile-phone data communication unit 212, a microphone/speaker unit 213, a display unit 214, a touch panel 215, and the GPS sensor 216. Moreover, the information processing apparatus 101 in FIG. 3 has a system bus 201. A CPU 202, a ROM 203, a RAM 204, a network controller 205, a voice controller 206, a display controller 207, an input controller 208, a storage device 209, and the position detecting controller 210 are connected to the system bus 201.

The wireless LAN communication unit 211 is a communication unit for joining in the network of the LAN 103 through the wireless LAN terminal 102. The mobile-phone data communication unit 212 is a communication unit for joining in a network that is provided by a mobile-phone carrier. The network controller 205 controls communication between the wireless LAN communication unit 211 and the mobile-phone data communication unit 212. When the wireless LAN communication unit 211 is able to join in the wireless LAN network, the network controller 205 gives priority to a connection by the wireless LAN. Thereby, the information processing apparatus 101 enables data communication with the image forming apparatus 104. The microphone/speaker unit 213 outputs and inputs voice data. The voice controller 206 controls input/output of voice by the microphone/speaker unit 213. When a user is telephoning using a telephone-call AP program, the voice controller 206 outputs voice based on voice data, which is obtained by the network controller 205, through a speaker. Moreover, the voice controller 206 outputs voice data that is input through a microphone to the network controller 205.

The display unit 214 displays an operation screen etc. The display controller 207 controls the display unit 214. The display controller 207 displays display data that is obtained by the network controller 205 onto the display unit 214, for example. The touch panel 215 detects a user's input operation to the display unit 214. The input control unit 208 controls the touch panel 215. The input controller 208 outputs a command etc. to the network controller 205 according to an operation input to the touch panel 215, for example.

The GPS sensor 216 detects the position of the information processing apparatus 101. The position detecting controller 210 controls the GPS sensor 216. The nonvolatile storage device 209 stores various operation mode setting, an operation log, etc. that are needed to hold after reboot of the information processing apparatus 101. The ROM 203 stores the OS program and AP programs that control telephone call and data communication in the information processing apparatus 101. The AP programs that control data communication include a mail program and a web-browser program, for example. The RAM 204 is a work memory area for running a program. The RAM 204 is used when the print AP program 406 generates a print job, for example. The CPU 202 reads the OS program and AP program 406 from the ROM 203, develops to the RAM 204, and runs them. Thereby, the controller of the information processing apparatus 101 is achieved.

FIG. 4 is an explanatory view showing examples of functions of the controller achieved in the information processing apparatus 101 by software. FIG. 4 shows a screen reader 410, a UI module 402, an image-forming-apparatus retrieval module 403, a print control module 404, and a scan control module 405 as examples of functions achieved in the information processing apparatus 101. In FIG. 4, the function by the OS program 401, the functions by the AP program 406 for the image forming apparatus, and the function by the other AP programs 407 are classified and illustrated.

FIG. 4 shows a state where the CPU 202 runs the AP program 406 together with the OS program 401 stored in the ROM 203. The screen reader 410 is one of the functions of the OS program 401 and is used to output voice. Some OS programs 401 for a mobile terminal are provided with the screen reader 410 for a visually impaired person. The screen reader 410 reads aloud contents of screens that are beforehand defined in the OS program 401.

A user is able to select an effective state or an ineffective state of the screen reader 410 according to the setting of the OS program 401. A setting value of this screen reader 410 is stored in the storage device 209. When the user designates change of the setting value, the setting value is updated and stored. When the setting of the screen reader 410 is effective, the screen reader 410 outputs voice guidance about a changed screen and a user's selection from the speaker through the voice controller 206 at a timing of changing the screen and a timing of selecting an item on the screen. When a change process is performed so as to change the display on the display unit 214 to a new screen, the screen reader 410 as a voice guidance function reads information associated with the new screen aloud.

The UI module 402, image-forming-apparatus retrieval module 403, print control module 404, and scan control module 405 are the functions achieved by the print AP program. The UI module 402 provides the user interface 312 for prompting a user to set a function inherent to the AP program 406. Thereby, the display unit 214 displays information, such as a status of the image forming apparatus 104 and a list of available image forming apparatuses. The image-forming-apparatus retrieval module 403 retrieves network apparatuses that the information processing apparatus 101 is able to manage by the SNMP in the LAN 103 to which the information processing apparatus 101 is connected. The image-forming-apparatus retrieval module 403 selects the image forming apparatus 104 that the information processing apparatus 101 is able to use for printing from among the retrieved apparatuses. The print control module 404 generates a print job and sends it to the image forming apparatus 104 that is communicable. The scan control module 405 communicates with the image forming apparatus 104 that mounts a scanning function as an MFP so as to cause the apparatus 104 to execute a scan job.

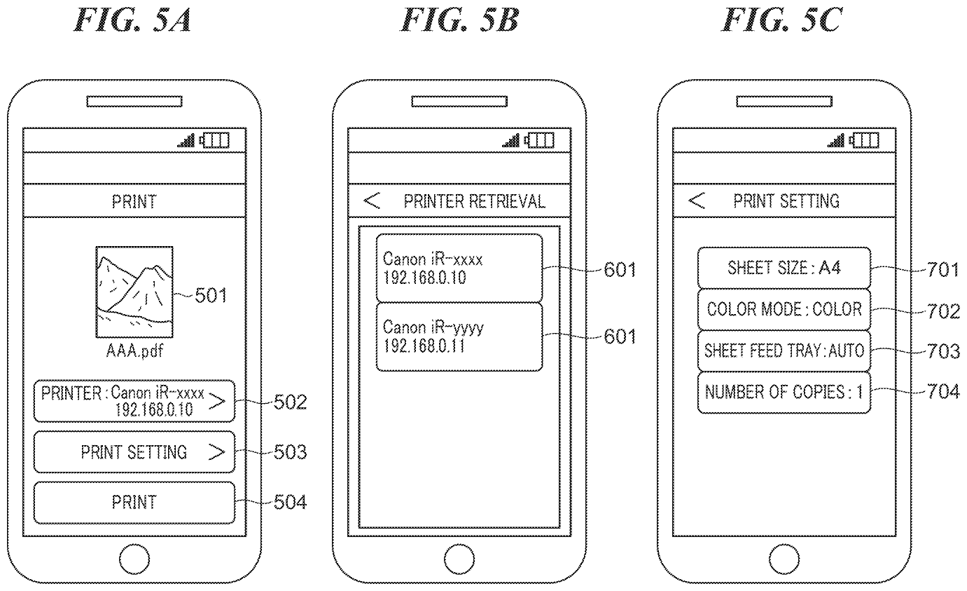

FIG. 5A, FIG. 5B, and FIG. 5C are explanatory views showing examples of screens displayed by the print AP program on the information processing apparatus in FIG. 2. When the CPU 202 runs the AP program 406, each of the screens in FIG. 5A, FIG. 5B, and FIG. 5C is displayed on the display unit 214. FIG. 5A shows a print screen displayed on the display unit 214 after activating the AP program 406. The print screen in FIG. 5A shows a state where the CPU 202 has already selected a target PDF file 501 and has selected the image forming apparatus 104 that executes a print job. A selection button 502 used to select an image forming apparatus that executes the print job, a print setting button 503, and a print start button 504 are displayed on the print screen in FIG. 5A. When determining that the selection button 502 is operated on the basis of a position of a user's operation on the touch panel 215 to the print screen in FIG. 5A, the CPU 202 displays a selection screen shown in FIG. 5B for selecting an image forming apparatus.

Selection buttons 601 for the respective image forming apparatuses that the information processing apparatus 101 is able to use for printing are displayed on the selection screen shown in FIG. 5B. The CPU 202 selects an image forming apparatus that executes a print job on the basis of a position of a user's operation on the touch panel 215 to the selection screen shown in FIG. 5B for selecting an image forming apparatus. After that, the CPU 202 displays the print screen that indicates the selected image forming apparatus 104 in the selection button 502 as shown in FIG. 5A. When determining that the print setting button 503 is operated on the basis of a position of a user's operation on the touch panel 215 to the print screen in FIG. 5A, the CPU 202 displays a print setting screen shown in FIG. 5C.

A print-sheet-size selection button 701, a color/monochrome selection button 702, a paper-feed-tray selection button 703, and a print-copies selection button 704 are displayed on the print setting screen shown in FIG. 5C. The CPU 202 determines which button is selected from among the buttons 701 through 704 on the basis of a position of a user's operation on the touch panel 215 to the print setting screen shown in FIG. 5C. Then, the CPU 202 displays a selection screen for a setting value corresponding to the selected button. The CPU 202 selects a setting value of the setting item corresponding to the selected button on the basis of a position of a user's operation on the touch panel 215 to the selection screen for the setting value.

After that, the CPU 202 displays the print screen that indicates the selected image forming apparatus 104 in the selection button 502 as shown in FIG. 5A. The CPU 202 selects the image forming apparatus that executes a print job and selects the setting values of the print setting items by repeating the above-mentioned process. After that, when determining that the print start button 504 is operated on the basis of a position of the user's operation on the touch panel 215 to the print screen in FIG. 5A, the CPU 202 generates a print job and sends it to the selected image forming apparatus 104.

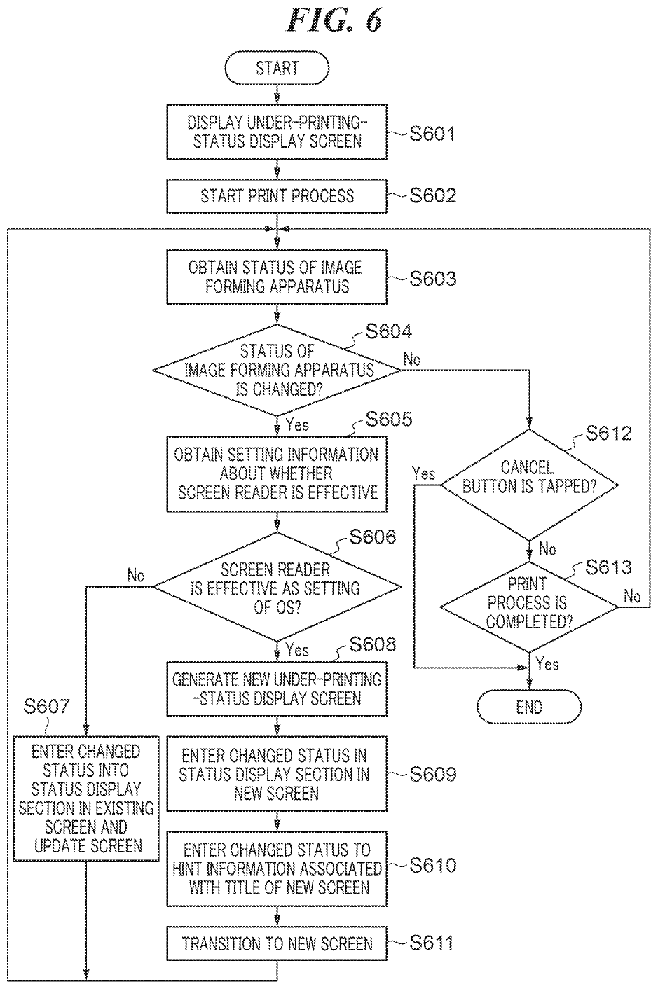

FIG. 6 is a flowchart showing a process for displaying a status of the image forming apparatus 104 under printing on the information processing apparatus 101 in the first embodiment of the present invention. After generating the print job and sending it to the image forming apparatus 104, the CPU 202 that runs the AP program 406 executes the process in FIG. 6. Since the CPU 202 is running the OS program 401, the CPU 202 executes the process in FIG. 6 in cooperation with the OS program 401 using the function provided by the OS program 401.

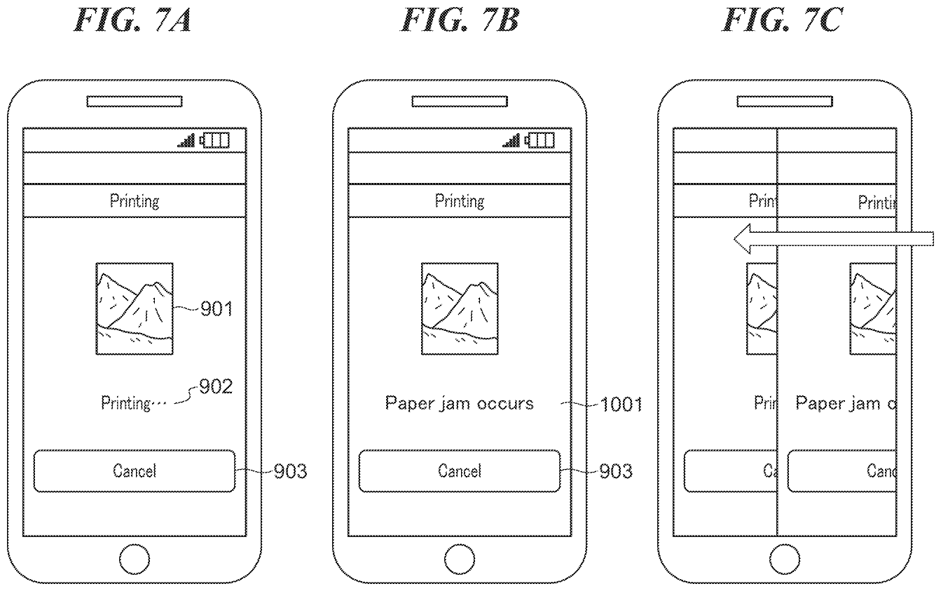

FIG. 7A, FIG. 7B, and FIG. 7C are explanatory views showing examples of screens displaying a status of the image forming apparatus 101 under printing displayed on the information processing apparatus 101 in FIG. 1. FIG. 7A shows an under-printing-status display screen displayed on the display unit 214 of the information processing apparatus 101 in a case where the image forming apparatus 104 is executing a print job without interruption. A character string 902 that reports that printing is under execution and a cancel button 903 are displayed on the under-printing-status display screen in FIG. 7A. FIG. 7B shows a status display screen displayed on the display unit 214 of the information processing apparatus 101 in a case where the image forming apparatus 104 interrupts the print job due to a paper jam. The cancel button 903 and a character string 1001 that reports that the paper jam occurred are displayed on the status display screen in FIG. 7B. FIG. 7C shows a transition screen displayed on the display unit 214 during transition from the screen in FIG. 7A to the screen in FIG. 7B. An arrow indicates the transition of the screen.

When the print start button 504 is operated, the CPU 202 of the information processing apparatus 101 displays the under-printing-status display screen in FIG. 7A on the display unit 214 in step S601. It should be noted that the CPU 202 makes the screen reader 410 of the OS program 401 read text data like metadata associated with the under-printing-status display screen aloud. The CPU 202 reports with voice that the printing is started, for example. Thereby, the user is able to receive voice feedback.

In step S602, the CPU 202 starts a print process. In the print process, the CPU 202 generates a print job by developing a document file selected by the user as a printing target, converting it into a drawing format that the image forming apparatus 104 selected by the user as a print destination supports, and adding the print setting information set by the user. Moreover, the CPU 202 sends the print job generated by designating the image forming apparatus 104 selected by the user as the print destination as a transmission destination. In step S603, the CPU 202 communicates with the image forming apparatus 104 and obtains the status of the image forming apparatus 104. Print statuses of the image forming apparatus 104 include a normal status and abnormal statuses. The abnormal statuses include a paper jam status and an out-of-toner status, for example.

In step S604, the CPU 202 determines whether the status of the image forming apparatus 104 obtained in the step S603 is changed from the status of the image forming apparatus 104 obtained at the previous time. Since there is no comparison target in determination at the first time, the CPU 202 determines whether the status is changed from the normal status. When the status is changed, the CPU 202 proceeds with the process to step S605. When the status is not changed, the CPU 202 proceeds with the process to step S612.

In the step S612, the CPU 202 determines whether the cancel button is operated (tapped) on the screen displayed. When the cancel button is not operated, the CPU 202 determines whether the print process is completed in step S613. When the print process is not completed, the CPU 202 returns the process to the step S603. Thereby, the CPU 202 repeats the process that obtains the status of the image forming apparatus 104 and determines whether the status is changed during printing. When the print process is completed still under printing, the CPU 202 determines that the print process is completed in the step S613, and finishes a process for monitoring the image forming apparatus 104 in FIG. 6. Moreover, when determining that the cancel button is operated in the step S612, the CPU 202 finishes the process for monitoring the image forming apparatus 104 in FIG. 6 regardless of the status of the image forming apparatus 104.

When determining that the status of the image forming apparatus 104 is changed from the status at the previous time in the step S604, the CPU 202 proceeds with the process to the step S605. In the step S605, the CPU 202 obtains the setting information about whether the screen reader 410 in the OS program 401 is effective as a process of the AP program 406. The CPU 202 that runs the OS program 401 notifies the AP program 406 of the setting information on the basis of the setting value of the screen reader 410 stored in the storage device 209.

In step S606, the CPU 202 determines whether the screen reader 410 is effective according to the obtained setting information. When the screen reader 410 is effective, the CPU 202 proceeds with the process to step S608. When the screen reader 410 is ineffective, the CPU 202 proceeds with the process to step S607. In the step S607, the CPU 202 enters a character string corresponding to the changed status into a status display section in the existing screen, and updates the screen displayed on the display unit 214. When the changed status is the paper jam status, the status display screen in FIG. 7A showing occurrence of the paper jam is displayed on the display unit 214. After that, the CPU 202 returns the process to the step S603. Thereby, the CPU 202 repeats the process that obtains the status of the image forming apparatus 104 and determines whether the status is changed during printing.

In the step S608, the CPU 202 generates a new under-printing-status display screen. In step S609, the CPU 202 enters the character string corresponding to the changed status into a status display section in the newly generated screen. In step S610, the CPU 202 enters a character string of the changed status used for the voice guidance into the metadata as hint information that is associated with a title of the new screen and is directed for the screen reader 410. The CPU 202 as a means for executing a change process generates the new display screen for displaying a new status of the image forming apparatus 104, when the status in connection with the job execution of the image forming apparatus obtained from the image forming apparatus 104 is changed. Moreover, the CPU 202 generates text data as metadata that is reads aloud to indicate the status of the image forming apparatus 104 under printing. That is, the CPU 202 generates metadata associated with a new display screen that is used to read the status of the image forming apparatus 104 aloud in addition to the new display screen.

In step S611, the CPU 202 executes a process of a screen transition to the screen that has been newly generated in the step S608. In order to transit to the new screen that has the same configuration as the under-printing-status display screen that is currently displayed, the display of the display unit 214 at the time of the transition process becomes a slide transition as shown in FIG. 7C. Thereby, the display of the display unit 214 is updated. After this screen transition, the CPU 202 that runs the OS program 401 reads the metadata associated with the new screen aloud with the effective screen reader 410. The CPU 202 reads the metadata as the title or hint information about the new screen aloud. The CPU 202 reads the generated metadata aloud with the screen reader 410, when the display is changed to the new display screen. The CPU 202 reads the generated metadata aloud, when the function of the screen reader 410 is effective. Thereby, the changed status is read aloud.

After that, the CPU 202 returns the process to the step S603. Thereby, the CPU 202 repeats the process that obtains the status of the image forming apparatus 104 and determines whether the status is changed during printing. When the status of the image forming apparatus 104 is changed to the abnormal statuses, such as the paper-jam status, the process for monitoring the image forming apparatus 104 in FIG. 6 continues until the status returns to the normal status. In order to finish the process for monitoring the image forming apparatus 104 in FIG. 6, the user is required to return the status of the image forming apparatus 104 to the normal status or to operate the cancel button.

As mentioned above, the CPU 202 as an obtaining means repeatedly and automatically obtains the status of the image forming apparatus 104 in this embodiment. Then, when the status is changed, the changed status is read aloud in real time. A visually impaired user is able to continue checking the status of the image forming apparatus 104 under printing in real time with voice, without display. Moreover, the voice guidance does not depend on a message function etc. that are provided by the CPU 202 that runs the OS program 401 in this embodiment. Accordingly, an operation to erase a message is not necessary even when a message is repeatedly displayed. A visually impaired user is able to continue checking the status in real time without continuing tapping the touch panel of the information processing apparatus 101.

In this embodiment, the status of the image forming apparatus 104 changes according to the process. The information processing apparatus 101 repeatedly and automatically obtains the status that is the information about the image forming apparatus 104 through the data communication. Then, when the status of the image forming apparatus 104 that should be reported to a user changes, the information processing apparatus 101 executes a change process for changing the metadata according to the change of the status of the image forming apparatus 104. The status of the image forming apparatus 104 that is changed according to the execution of the change process for changing the metadata is read aloud. Accordingly, the information processing apparatus 101 is able to appropriately read the changed status of the image forming apparatus 104 aloud, when the status of the image forming apparatus 104 changes.

In this embodiment, the status of the image forming apparatus 104 is a status about the print process displayed on the image forming apparatus 104 during printing. In this case, the information processing apparatus 101 repeatedly and automatically obtains the status about the print process displayed on the image forming apparatus 104 during printing. Then, the information processing apparatus 101 generates the metadata for reading the status of the image forming apparatus 104 under printing aloud in addition to the new display screen for displaying the status of the image forming apparatus 104 under printing. Thereby, the information processing apparatus 101 is able to appropriately read the changed status about printing of the image forming apparatus 104 aloud, when the status about printing of the image forming apparatus 104 changes.

Particularly, since the print AP program 406 is installed together with the OS program 401 to the information processing apparatus 101 in this embodiment, the above-mentioned process is executed in the information processing apparatus 101 by the CPU 202 running the print AP program 406. Accordingly, the AP program 406 is able to suitably use the screen reader 410, which is achieved in the information processing apparatus 101 by the CPU 202 running the OS program 401, for the voice guidance. The screen reader 410 in this case reads the metadata associated with the display screen aloud, when the display of the display unit 214 is changed to the new display screen.

Not all the processes for executing the above-mentioned processes may be described in the AP program 406. In this embodiment, the change process newly generates the display screen for displaying the changed status obtained from the image forming apparatus 104 or the changed information about available image forming apparatuses on the display unit 214. Thereby, the display of the display unit 214 is updated. Moreover, the information processing apparatus 101 generates the metadata, which is associated with a new display screen, for reading the status of the image forming apparatus 104 aloud or for reading the information about the available image forming apparatuses aloud in addition to the new display screen. Accordingly, when the display of the display unit 214 is changed to a new display screen, the screen reader 410 that is provided by the OS program 401 and reads the metadata associated with the display screen is able to be used suitably.

The screen reader 410 is able to read the metadata about the status of the image forming apparatus 104 or the information about the available image forming apparatuses aloud, when the display is changed to the new display screen. Moreover, the screen reader 410 reads the generated metadata aloud, when the voice guidance function is effective in the information processing apparatus 101.

Next, the information processing system 100 concerning a second embodiment of the present invention will be described. In this embodiment, the information processing apparatus 101 runs the AP program 406. Then, the information processing apparatus 101 makes the image forming apparatus 104 execute a scan process, obtains a status of the image forming apparatus 104 during scanning, and outputs it with display and voice. The following description mainly describes difference from the first embodiment.

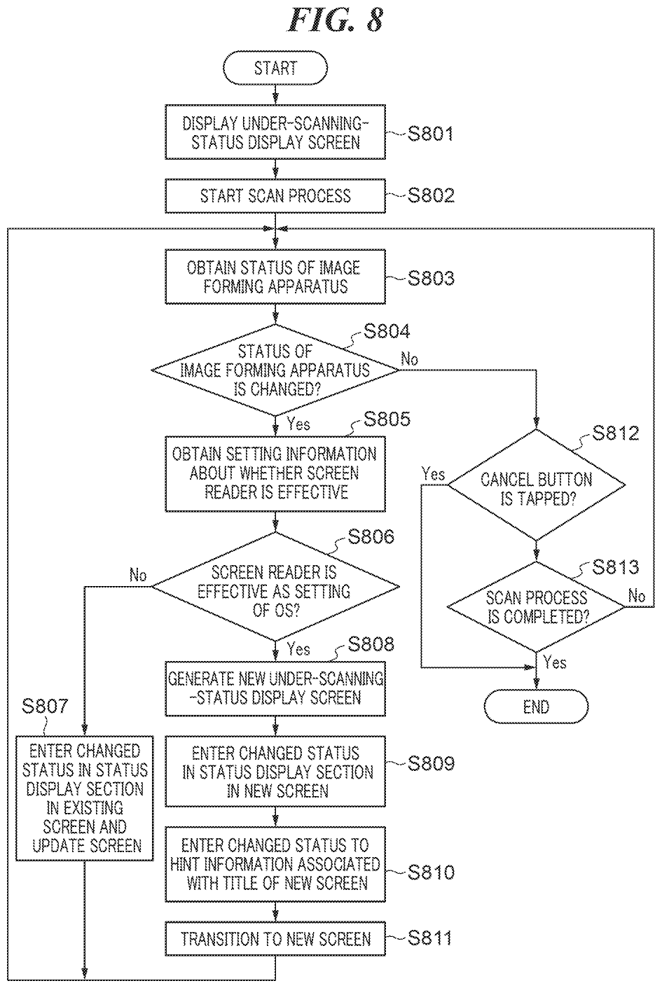

FIG. 8 is a flowchart showing a process for displaying the status of the image forming apparatus 104 under scanning on the information processing apparatus 101 in the second embodiment of the present invention. After generating a scan job and sending it to the image forming apparatus 104, the CPU 202 that runs the AP program 406 executes the process in FIG. 8. Since the CPU 202 is running the OS program 401, the CPU 202 executes the process in FIG. 8 using the function provided by the OS program 401 in cooperation with the OS program 401.

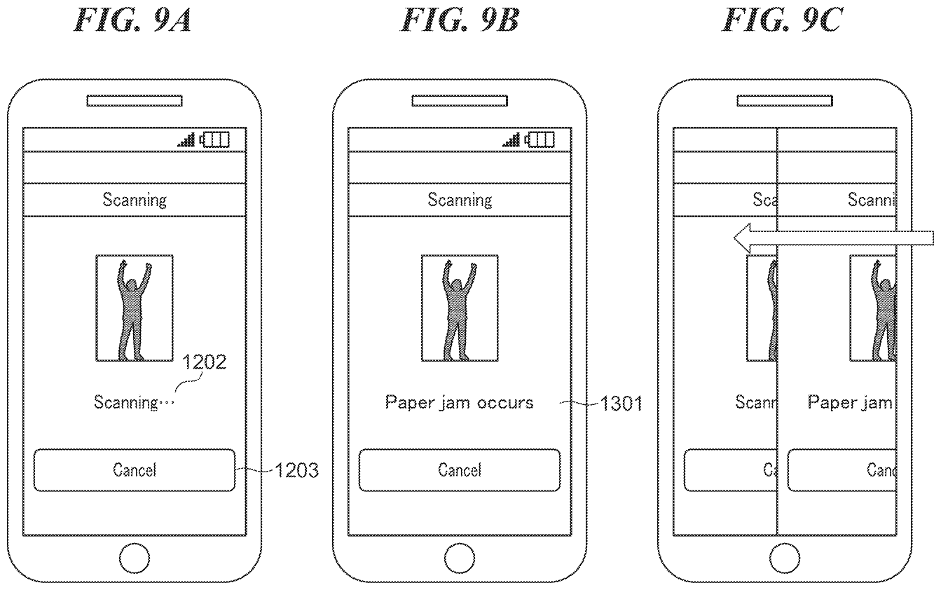

FIG. 9A, FIG. 9B, and FIG. 9C are the explanatory views showing examples of screens displaying a status of the image forming apparatus 104 under scanning displayed on the information processing apparatus 101. FIG. 9A shows an under-scanning-status display screen displayed on the display unit 214 of the information processing apparatus 101 in a case where the image forming apparatus 104 is executing a scan job without interruption. A character string 1202 that reports that scanning is under execution and a cancel button 1203 are displayed on the under-scanning-status display screen in FIG. 9A. FIG. 9B shows a status display screen displayed on the display unit 214 of the information processing apparatus 101, when the image forming apparatus 104 interrupts the scan job due to a paper jam of a document. A character string 1301 that reports that the paper jam occurred and the cancel button 1203 are displayed on the status display screen in FIG. 9B. FIG. 9C shows a transition screen displayed on the display unit 214 during transition from the screen in FIG. 9A to the screen in FIG. 9B. An arrow indicates the transition of the screen.

When a scan button is operated, the CPU 202 of the information processing apparatus 101 displays the under-scanning-status display screen in FIG. 9A on the display unit 214 in step S801. It should be noted that the CPU 202 notifies a user of the metadata associated with the under-scanning-status display screen with voice by the screen reader 410 of the OS program 401. The CPU 202 reports with voice that the scanning starts, for example. Thereby, the user is able to receive voice feedback.

In step S802, the CPU 202 starts a scan process. The CPU 202 sends a control command that instructs to read a paper document placed on a document reading plate of the image forming apparatus 104 having a scanning function to the image forming apparatus 104 in the scan process. After that, the CPU 202 receives image data of the read paper document from the image forming apparatus 104.

In step S803, the CPU 202 communicates with the image forming apparatus 104 and obtains a status of the image forming apparatus 104. Scanning statuses of the image forming apparatus 104 include a normal status and abnormal statuses. The abnormal statuses include a paper-jam status showing that a document jams and a cover-open status showing that a document platen is not closed, for example.

In step S804, the CPU 202 determines whether the status of the image forming apparatus 104 obtained in the step S803 is changed from the status of the image forming apparatus 104 obtained at the previous time. Since there is no comparison target in determination at the first time, the CPU 202 determines whether the status is changed from the normal status. When the status is changed, the CPU 202 proceeds with the process to S805. When the status did not change, the CPU 202 proceeds with the process to step S812.

In the step S812, the CPU 202 determines whether the cancel button is operated on the displayed screen. When the cancel button is not operated, the CPU 202 determines whether the scan process is completed in step S813. When the scan process is not completed, the CPU 202 returns the process to the step S803. Thereby, the CPU 202 repeats the process that obtains the status of the image forming apparatus 104 automatically and determines whether the status is changed during scanning.

When the scan process is completed still under scanning, the CPU 202 determines that the scan process is completed in the step S813 and finishes the process for monitoring the image forming apparatus 104 in FIG. 8. Moreover, when determining that the cancel button is operated in the step S812, the CPU 202 finishes the process for monitoring the image forming apparatus 104 in FIG. 8 regardless of the status of the image forming apparatus 104.

When determining that the status of the image forming apparatus 104 is changed from the status at the previous time in the step S804, the CPU 202 proceeds with the process to the step S805. In the step S805, the CPU 202 obtains the setting information about whether the screen reader 410 in the OS program 401 is effective as a process of the AP program 406. The CPU 202 that runs the OS program 401 notifies the AP program 406 of the setting information on the basis of the setting value of the screen reader 410 recorded in the storage device 209.

In step S806, the CPU 202 determines whether the screen reader 410 is effective on the basis of the obtained setting information. When the screen reader 410 is effective, the CPU 202 proceeds with the process to step S808. When the screen reader 410 is ineffective, the CPU 202 proceeds with the process to step S807. In the step S807, the CPU 202 enters a character string corresponding to the changed status to the status display screen and updates the screen displayed on the display unit 214. When the changed status is the paper-jam status, the display unit 214 displays the status display screen showing occurrence of the paper jam shown in FIG. 9B. After that, the CPU 202 returns the process to the step S803. Thereby, the CPU 202 repeats the process that obtains the status of the image forming apparatus 104 and determines whether the status is changed during scanning.

In the step S808, the CPU 202 generates a new status display screen. In step S809, the CPU 202 enters a character string corresponding to the changed status into a status display section in the newly generated screen. In step S810, the CPU 202 enters a character string of the changed status into the metadata as hint information that is associated with a title of the new screen and is directed for the screen reader 410.

The CPU 202 as the means for executing the change process generates a new display screen for displaying a new status of the image forming apparatus 104, when the status obtained from the image forming apparatus 104 is changed. Moreover, the CPU 202 generates the metadata for reading the status of the image forming apparatus 104 under scanning. That is, the CPU 202 generates metadata associated with a new display screen that is used to read the status of the image forming apparatus 104 aloud in addition to the new display screen.

In step S811, the CPU 202 executes a transition process that transits the display to the screen that has been newly generated in the step S808. In order to transit to the new screen that has the same configuration as the under-scanning-status display screen that is currently displayed, the display of the display unit 214 at the time of the transition process becomes a slide transition as shown in FIG. 9C. Accordingly, the display of the display unit 214 is updated. After this screen transition, the CPU 202 that runs the OS program 401 reads the metadata associated with the new screen aloud with the effective screen reader 410. The CPU 202 reads the metadata as the title or hint information about the new screen aloud. The CPU 202 reads the generated metadata aloud with the screen reader 410, when the display is changed to the new display screen. The CPU 202 reads the generated metadata aloud, when the function of the screen reader 410 is effective. Thereby, the changed status is read aloud.

After that, the CPU 202 returns the process to the step S803. Thereby, the CPU 202 repeats the process that obtains the status of the image forming apparatus 104 and determines whether the status is changed during scanning. When the status of the image forming apparatus 104 is changed to the abnormal statuses, such as the paper-jam status, the process for monitoring the image forming apparatus 104 in FIG. 8 continues until the status returns to the normal status. In order to finish the process for monitoring the image forming apparatus 104 in FIG. 8, the user is required to return the status of the image forming apparatus 104 to the normal status or to operate the cancel button.

As mentioned above, the CPU 202 as the obtaining means repeatedly and automatically obtains the status of the image forming apparatus 104 in this embodiment. Then, when the status is changed, the changed status is read aloud in real time. A visually impaired user is able to continue checking the status of the image forming apparatus 104 under scanning in real time with voice, without display. Moreover, the voice guidance does not depend on a message function etc. that are provided by the CPU 202 that runs the OS program 401 in this embodiment. Accordingly, an operation to erase a message is not necessary even when a message is repeatedly displayed.

A visually impaired user is able to continue checking the status in real time without continuing tapping the touch panel of the information processing apparatus 101. In this embodiment, the status of the image forming apparatus 104 is changed according to the process. The information processing apparatus 101 repeatedly and automatically obtains the status of the image forming apparatus 104 through the data communication. Then, when the status of the image forming apparatus 104 is changed, the information processing apparatus 101 executes a change process corresponding to the change of the status of the image forming apparatus 104. The status of the image forming apparatus 104 that is changed according to the execution of the change process is read aloud. Accordingly, the information processing apparatus 101 is able to appropriately read the changed status of the image forming apparatus 104 aloud, when the status of the image forming apparatus 104 changes.

In this embodiment, the status of the image forming apparatus 104 about the scan process is displayed on the image forming apparatus 104 during scanning. In this case, the information processing apparatus 101 repeatedly and automatically obtains the status about the scan process displayed on the image forming apparatus 104 during scanning. Then, the information processing apparatus 101 generates the metadata for reading the status of the image forming apparatus 104 under scanning aloud in addition to the new display screen for displaying the status of the image forming apparatus 104 under scanning. Thereby, the information processing apparatus 101 is able to appropriately read the changed status about scanning of the image forming apparatus 104 aloud, when the status about scanning of the image forming apparatus 104 changes.

Particularly, since the information processing apparatus 101 has the CPU 202 that runs the AP program 406 together with the OS program 401 in this embodiment, the above-mentioned process is executed in the information processing apparatus 101 by the CPU 202 running the AP program 406. Accordingly, the AP program 406 is able to suitably use the screen reader 410, which is achieved in the information processing apparatus 101 by the CPU 202 running the OS program 401, for the voice guidance. The screen reader 410 in this case reads the metadata associated with the display screen aloud, when the display of the display unit 214 is changed to the new display screen. Not all the above-mentioned processes may be described in the AP program 406.

Next, the information processing system 100 concerning a third embodiment of the present invention will be described. In this embodiment, the information processing apparatus 101 runs the AP program 406. Then, the information processing apparatus 101 executes a process for retrieving an available image forming apparatus, obtains a status about retrieval of an image forming apparatus during the retrieval, and outputs it with display and voice. The following description mainly describes difference from the first embodiment.

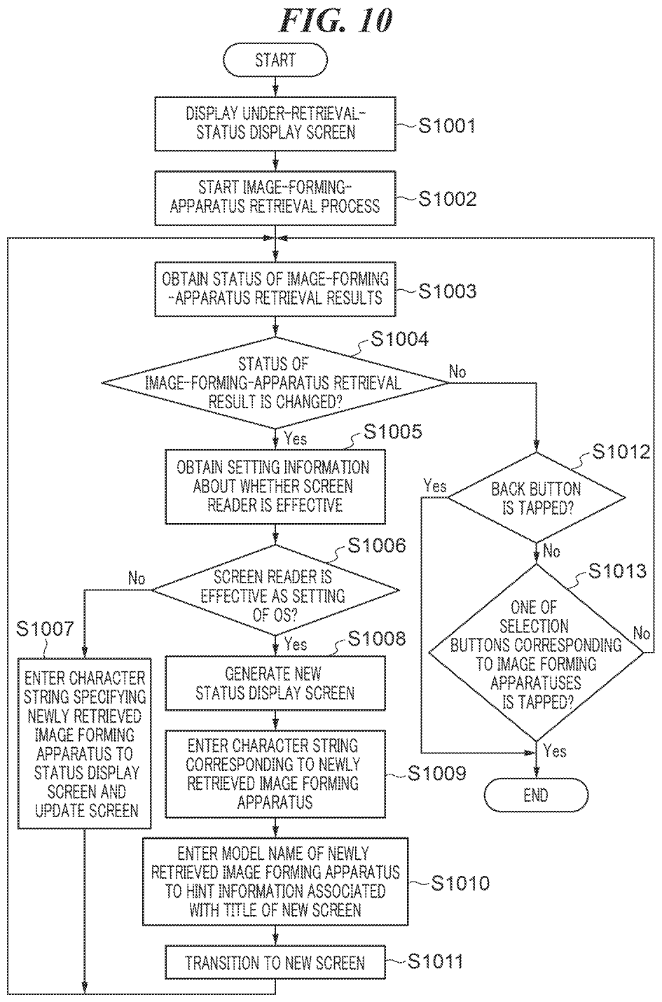

FIG. 10 is a flowchart showing a process for retrieving and displaying an image forming apparatus in the third embodiment of the present invention. The CPU 202 that runs the AP program 406 executes the process in FIG. 10 after requiring a process for retrieving an image forming apparatus from the CPU 202 that runs the OS program 401. Since the CPU 202 is running the OS program 401, the CPU 202 executes the process in FIG. 10 in cooperation with the OS program 401 using the function provided by the OS program 401.

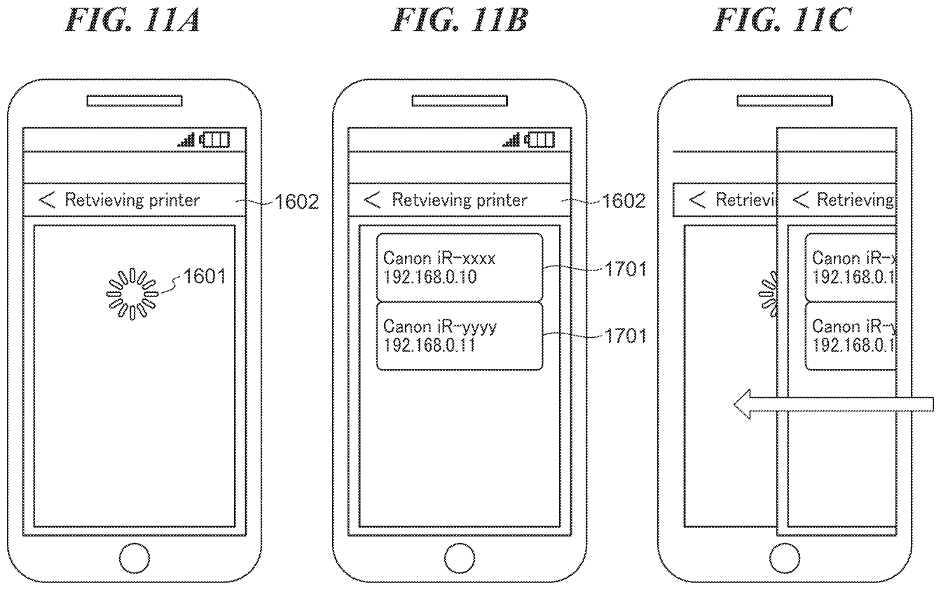

FIG. 11A, FIG. 11B, and FIG. 11C are explanatory views showing examples of screens displayed on the information processing apparatus 101 during retrieval of an image forming apparatus. FIG. 11A shows an under-retrieval-status display screen displayed on the display unit 214 of the information processing apparatus 101 in a case where the information processing apparatus 101 is executing the process for retrieving an image forming apparatus without interruption. An icon 1601 reporting the status under retrieval of an image forming apparatus and a back button 1602 for returning to the previous screen are displayed on the under-retrieval status display screen in FIG. 11A. FIG. 11B is a status display screen displayed on the display unit 214 of the information processing apparatus 101, when available image forming apparatuses are retrieved. Selection buttons 1701 that respectively include character strings indicating the available image forming apparatuses retrieved and the back button 1602 for returning to the previous screen are displayed on the status display screen in FIG. 11B. A user is able to tap either of the listed selection buttons 1701 corresponding to the image forming apparatuses 104 and 105 displayed on the status display screen in FIG. 11B. When tapping either of the listed selection buttons indicating the image forming apparatuses, the user is able to select the image forming apparatus corresponding to the tapped button as a target used for printing etc. FIG. 11C shows a transition screen displayed on the display unit 214 during transition from the screen in FIG. 11A to the screen in FIG. 11B. An arrow indicates the transition of the screen.

When a retrieval start button is operated, the CPU 202 of the information processing apparatus 101 displays the under-retrieval-status display screen in FIG. 11A on the display unit 214 in step S1001. It should be noted that the CPU 202 notifies a user of the metadata associated with the under-retrieval-status display screen with voice by the screen reader 410 of the OS program 401. The CPU 202 reports with voice that the retrieval is started, for example. Thereby, the user is able to receive voice feedback.

In step S1002, the CPU 202 starts an image-forming-apparatus retrieval process. In the retrieval process, the CPU 202 retrieves a network device that is managed by SNMP (Simple Network Management Protocol) in the LAN 103 to which the information processing apparatus 101 is connected. Moreover, the CPU 202 picks up an available image forming apparatus from among the network devices retrieved. When an image forming apparatus is in a ready state, a period required for picking up is 2 to 3 seconds or less. However, when an image forming apparatus is in a sleep state, a period required for picking up may become about 10 seconds.

In step S1003, the CPU 202 communicates with the CPU 202 that runs the OS program 401 and obtains a status of an image-forming-apparatus retrieval result. The status of the image-forming-apparatus retrieval result includes a retrieval result of an image forming apparatus that has been already retrieved and a retrieval result of an image forming apparatus that is newly retrieved.

In step S1004, the CPU 202 determines whether the status of the image-forming-apparatus retrieval result obtained in the step S1003 is changed from the status of the image-forming-apparatus retrieval result obtained at the previous time. Since there is no comparison target in determination at the first time, the CPU 202 determines whether the status is changed from a status of a case where no image forming apparatus is retrieved. When the status is changed, the CPU 202 proceeds with the process to step S1005. When the status is not changed, the CPU 202 proceeds with the process to step S1012.

In the step S1012, the CPU 202 determines whether the back button of the information processing apparatus 101 is operated on the displayed screen. When the back button is not operated, the CPU 202 determines whether the retrieval process is completed in step S1013. The CPU 202 determines whether the user taps either of the selection buttons corresponding to the retrieved image forming apparatuses in the step S1013. When determining that one of the selection buttons is tapped, the CPU 202 determines that the retrieval process is completed. When the retrieval process is not completed, the CPU 202 returns the process to the step S1003. Thereby, the CPU 202 repeats the process that obtains the status of the image-forming-apparatus retrieval result automatically and determines whether the status is changed during retrieval.

When the retrieval process is completed, the CPU 202 finishes the process for monitoring the image-forming-apparatus retrieval result in FIG. 10. Moreover, when determining that the back button is operated in the step S1012, the CPU 202 finishes the process for monitoring the image-forming-apparatus retrieval result in FIG. 10 regardless of the status of the image-forming-apparatus retrieval result.

When determining that the status of the image-forming-apparatus retrieval result is changed from the status at the previous time in the step S1004, the CPU 202 proceeds with the process to the step S1005. In the step S1005, the CPU 202 obtains the setting information about whether the screen reader 410 in the OS program 401 is effective as the process of the AP program 406.

The CPU 202 that runs the OS program 401 notifies the AP program 406 of the setting information on the basis of the setting value of the screen reader 410 recorded in the storage device 209. In step S1006, the CPU 202 determines whether the screen reader 410 is effective according to the obtained setting information. When the screen reader 410 is effective, the CPU 202 proceeds with the process to step S1008. When the screen reader 410 is ineffective, the CPU 202 proceeds with the process to step S1007.

In the step S1007, the CPU 202 enters a character string specifying a newly retrieved image forming apparatus to the status display screen and updates the screen displayed on the display unit 214. The status display screen in FIG. 11B that displays the selection buttons corresponding to the image forming apparatuses 104 and 105 is displayed on the display unit 214. After that, the CPU 202 returns the process to the step S1003. Thereby, the CPU 202 repeats the process that obtains the status of the image-forming-apparatus retrieval result and determines whether the status is changed during retrieval.

In the step S1008, the CPU 202 generates a new status display screen for displaying the newly retrieved image forming apparatus. In step S1009, the CPU 202 enters a character string corresponding to the newly retrieved image forming apparatus to a status display section in the newly generated screen. The CPU 202 may list the picked-up image forming apparatuses in the order of retrieval.

In step S1010, the CPU 202 enters a character string corresponding to the newly retrieved image forming apparatus into the metadata as hint information that is associated with a title of the new screen and is directed for the screen reader 410. The character string corresponding to the image forming apparatus may be a model name, for example. The CPU 202 as the means for executing the change process generates a new display screen that displays the statuses of the image forming apparatuses 104 and 105, when the status of the image-forming-apparatus retrieval result, which is the information about available image forming apparatuses that are found by the network retrieval, is changed. The new display screen includes the newly retrieved image forming apparatus.

Moreover, the CPU 202 generates and changes metadata for reading the information about the additional image forming apparatus that is newly retrieved as an available apparatus aloud. That is, the CPU 202 generates the metadata for reading the information about the newly retrieved image forming apparatus aloud as the metadata associated with the new display screen in addition to the new display screen. In step S1011, the CPU 202 executes a process of a screen transition to the screen that has been newly generated in the step S1008. In order to transit to the new screen that has the same configuration as the status display screen of the retrieval result that is currently displayed, the display of the display unit 214 at the time of the transition process becomes a slide transition as shown in FIG. 11C. Thereby, the display of the display unit 214 is updated. After this screen transition, the CPU 202 that runs the OS program 401 reads the metadata associated with the new screen aloud with the effective screen reader 410. The CPU 202 reads the metadata as the title or hint information about the new screen aloud. The CPU 202 reads the generated metadata aloud with the screen reader 410, when the display is changed to the new display screen. The CPU 202 reads the generated metadata aloud, when the function of the screen reader 410 is effective. Thereby, the changed status is read aloud. After that, the CPU 202 returns the process to the step S1003. Thereby, the CPU 202 repeats the process that obtains the status of the image-forming-apparatus retrieval result and determines whether the status is changed during retrieval. It should be noted that the CPU 202 continues the process for monitoring the image-forming-apparatus retrieval result in FIG. 10 until the back button is operated.

As mentioned above, the CPU 202 as the obtaining means repeatedly and automatically obtains the status of the image-forming-apparatus retrieval result in this embodiment. Then, when the status is changed, the information about the newly retrieved image forming apparatus is read aloud in real time. A visually impaired user is able to continue checking the newly retrieved image forming apparatus with voice, without display.

Moreover, the voice guidance does not depend on a message function etc. that are provided by the CPU 202 that runs the OS program 401 in this embodiment. Accordingly, an operation to erase a message is not necessary even when a message is repeatedly displayed. A visually impaired user is able to continue checking the status in real time without continuing tapping the touch panel of the information processing apparatus 101. In the above description, not all the listed model names of the image forming apparatuses are entered, and only the model name of the additional image forming apparatus is entered. This prevents from reading the information about the same image forming apparatus aloud repeatedly. In the meantime, all the listed model names of the image forming apparatuses may be entered so that all the listed model names of the image forming apparatuses will be read aloud whenever a new image forming apparatus is retrieved.

In this embodiment, the information processing apparatus 101 repeatedly and automatically obtains the information about an available image forming apparatus through the data communication. Then, when the information about the available image forming apparatuses is changed, the information processing apparatus 101 performs the change process corresponding to the change of the information and reads the information about the available image forming apparatus aloud. Accordingly, the information processing apparatus 101 is able to appropriately read the changed information about the available image forming apparatuses aloud, when the available image forming apparatuses change.

In this embodiment, the information processing apparatus 101 repeatedly and automatically obtains the information about the available image forming apparatuses. Then, the information processing apparatus 101 generates the metadata for reading the information about the available image forming apparatuses aloud in addition to the new display screen for displaying the information about the available image forming apparatuses. The information processing apparatus 101 generates metadata for reading information about an additional image forming apparatus that becomes newly available aloud. Thereby, the information processing apparatus 101 is able to appropriately read the information about the additional image forming apparatus that becomes available when the available image forming apparatuses change.

It should be noted that the information processing apparatus 101 may generate the metadata for reading the information about all the image forming apparatuses displayed on the new display screen. Particularly, since the information processing apparatus 101 has the CPU 202 that runs the AP program 406 together with the OS program 401 in this embodiment, the above-mentioned process is executed in the information processing apparatus 101 by the CPU 202 running the AP program 406. Accordingly, the AP program 406 is able to suitably use the screen reader 410, which is achieved in the information processing apparatus 101 by the CPU 202 running the OS program 401, for the voice guidance. The screen reader 410 in this case reads the metadata associated with the display screen aloud, when the display of the display unit 214 is changed to the new display screen. Not all the above-mentioned processes may be described in the AP program 406.

Next, the information processing system 100 concerning a fourth embodiment of the present invention will be described. In the first, second, and third embodiments, the screen transition is used as a trigger of the voice guidance with the screen reader 410. In this embodiment, the functions of both the OS program 401 and AP program 406 are extended to read the changed status aloud according to the change of the status. This improves accessibility.

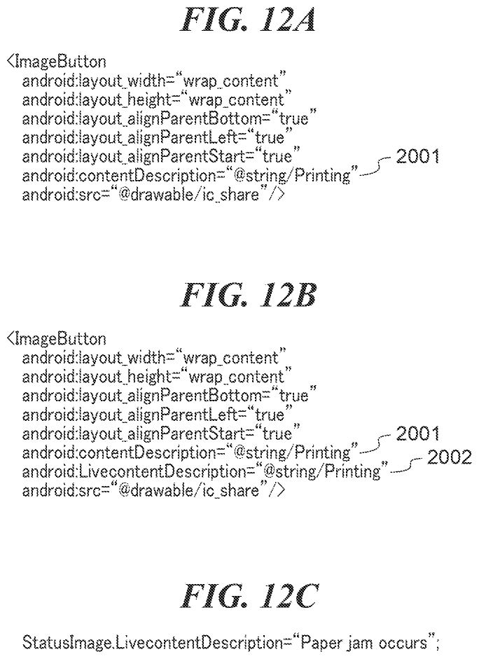

FIG. 12A, FIG. 12B, and FIG. 12C are explanatory views showing display UI components of the information processing apparatus 101 in the fourth embodiment of the present invention. FIG. 12A is an explanatory view of a display UI component that is standardly provided by the OS program 401. Attribute information 2001 of the UI component in FIG. 12A is equivalent to the hint information described in the above-mentioned embodiments. The CPU 202 that runs the OS program 401 detects that a displaying item of the UI component is tapped. The CPU 202 obtains a character string set as an attribute value of the “contentDescription” attribute information 2001 in response to the detection and makes the screen reader 410 read it aloud.

FIG. 12B is an explanatory view of an extended display UI component in this embodiment. In the display UI component in FIG. 12B, attribute information 2002 of “LivecontentDescription” is added to the display UI component in FIG. 12A. The attribute information 2002 is used when a developer of the AP program 406 wants to notify the OS program 401 or screen reader 410 that the developer changed a content dynamically. For example, when a content is dynamically changed, the AP program 406 rewrites the attribute information 2002 that is the metadata about the dynamic content. Moreover, when the status of the image forming apparatus 104, which is the information that should be reported to a user, is changed from “under printing” to “paper jam”, the AP program 406 rewrites the attribute information 2002 that is the metadata about the dynamic content.

The CPU 202 that runs the OS program 401 detects the change of the attribute information 2002 as an event. For example, a function for handling an event, which includes the fact that the attribute information concerned is changed and the changed character string, is incorporated into an execution platform of the AP program 406 that is provided by the OS program 401. Moreover, a layout editor that arranges the UI component described in FIG. 12B and a code editor that accepts input of a program code for controlling behavior of an application are provided as an integrated development environment of the AP program 406 for the OS program 401.

Moreover, the integrated development environment includes a code library for generating the event concerned and a compiler that compiles a program code. That is, a framework is built so that the above-mentioned event will be thrown in response to the change of the attribute information (LivecontentDescription) of the UI component. When a user's operation for building a source code including such a change of the attribute information is performed, the compiler performs a compile process and a linker associates the code library. As the result, an application execution file including an intermediate code or a binary code that causes the above-mentioned event is generated by using the dynamic change process of the content as a trigger.

According to this scheme of the OS program 401, the AP program 406 is able to easily notify the OS program 401 of the change of the dynamic content that occurs on the AP program 406. Then, when detecting occurrence of the event concerned, the CPU 202 that runs the OS program 401 notifies the screen reader 410 of the changed character string. When receiving the notification, the screen reader 410 outputs voice according to the changed character string received.

FIG. 12C is an example of a code for rewriting the attribute information 2002 to dynamically change the display content displayed on the UI component. An object “StatusImage” is a real object (an instance) of the UI component. The developer of the AP program 406 sets a property “LivecontentDescription” of the real object (instance) to a character string (“Paper jam occurs” in this example) describing the changed content. The developer of the AP program 406 adds a one line of the code that rewrites this attribute information 2002 to the AP program 406 using the code editor.

When the source file including the added code is built according to the acceptance of the above-mentioned user's operation, the above-mentioned application execution file including the intermediate code or binary code that causes the above-mentioned event is generated.

When the scheme of this embodiment is applied to the first embodiment, the CPU 202 executes the process for changing the attribute value of the attribute information 2002 of the UI component in place of the process in the steps S608 to S611 in FIG. 6. In this case, the attribute value of “LivecontentDescription” should be the character string of the changed status. In addition, contents, such as a character string and an image indicating a character string, that should be displayed on the UI component may be changed. Accordingly, the CPU 202 that runs the extended OS program 401 detects the event that indicates the change of the status on the basis of the change of the attribute value of the attribute information 2002. Continuously, the CPU 202 handles the event that occurs in response to the change of the attribute information 2002 with the AP program 406. Specifically, the CPU 202 notifies the screen reader 410 of the character string included in the event and makes the screen reader 410 read it aloud.

Moreover, when the scheme of this embodiment is applied to the second embodiment, the CPU 202 executes the process for changing the value of the “LivecontentDescription” attribute information 2002 of the UI component in place of the process in the steps S808 to S811 in FIG. 8. In this case, the value of “LivecontentDescription” should be the character string of the changed status. In addition, contents, such as a character string and an image indicating a character string, that should be displayed on the UI component may be changed. In this case, the process executed by the CPU 202 that runs the extended OS program 401 is the same as what is mentioned above.

Moreover, when the scheme of this embodiment is applied to the third embodiment, the CPU 202 executes the process for changing the value of the “LivecontentDescription” attribute information 2002 of the UI component in place of the process in the steps S1008 to S1011 in FIG. 10. In this case, the value of “LivecontentDescription” should be the character string of the additional model name that is the changed status. In addition, contents, such as a character string and an image indicating a character string, that should be displayed on the UI component may be changed. In this case, the process executed by the CPU 202 that runs the extended OS program 401 is the same as what is mentioned above.

As mentioned above, the AP program 406 is able to notify the extended OS program 401 that the status is dynamically changed as the change of the content in this embodiment. The CPU 202 that runs the extended OS program 401 obtains and handles the event and outputs the changed status with voice.

In this embodiment, the information processing apparatus 101 updates the attribute value of the attribute information 2002 of the display UI component of the information processing apparatus 101 provided by the OS program 401 in the process based on the AP program 406. Moreover, the information processing apparatus 101 changes the display text data, which is a kind of metadata, of the display UI component to the changed status of the image forming apparatus 104 or the changed information about available image forming apparatuses. In this case, the information processing apparatus 101 that runs the OS program 401 obtains the display text data from the display UI component on the basis of the event that changes the attribute value of the display UI component.

Moreover, the information processing apparatus 101 is able to notify the screen reader 410 that reads the text data aloud. As a result, the changed status of the image forming apparatus 104 or the information about the available image forming apparatuses is read aloud in this embodiment. Accordingly, the AP program 406 is able to suitably use the screen reader 410, which is achieved in the information processing apparatus 101 by the CPU 202 running the OS program 401, and the notification function to the screen reader 410 for the voice guidance process. The screen reader 410 in this case should read the received text data aloud, for example. Not all the above-mentioned processes may be described in the AP program 406.

Moreover, the dynamic update of a part of the display contents constituting the operation screen and the change of the metadata showing the update content, which are the contents about the operation screen provided by the application running on the information processing apparatus 101, are detected in this embodiment. Then, when the change is detected, the voice guidance based on the updated metadata is output in this embodiment.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-161687, filed Aug. 30, 2018, which is hereby incorporated by reference herein in its entirety.

What is claimed is:

1. An information processing apparatus comprising:
at least one memory that stores a set of instructions; and
at least one processor that executes the set of instructions to:
detect that one of display components that constitute an operation screen provided by an application running on the information processing apparatus has been dynamically changed;
execute a set of instructions that constitutes the application that causes control for changing attribute information about a dynamic content associated with the changed display component by the at least one processor;
receive a fact that the display component has been dynamically changed and the attribute information showing the changed content of the dynamic content from the application using an operating system in response to the execution; and
output voice guidance with a screen reader according to the attribute information received using the operating system.

2. An application development environment providing system comprising:
a layout editor that is able to arrange a first-type display component;
a code editor that receives input of a program code; and
a compiler that compiles the program code,
wherein an instance corresponding to the first-type display component arranged using the layout editor includes at least a first accessibility attribute that shows a description of the display component and a second accessibility attribute showing that a content shown by the display component is changed, and
wherein the compiler compiles a program code that changes the second accessibility attribute of the instance into a set of instructions that sends a fact that the display component has been dynamically changed together with information showing a changed content of the content to an operating system.

3. The application development environment providing system according to claim 2, wherein the first-type display component is an image button component.

4. A control method for an information processing apparatus that is communicable with an image forming apparatus, the control method comprising:
obtaining information relevant to the image forming apparatus;
executing a change process that changes metadata used for voice guidance in a case where it is determined that information that should be reported to a user among information about the image forming apparatus has been changed according to the obtained information; and
reading the changed information about the image forming apparatus aloud with a voice guidance function in response to the execution of the change process.

5. The control method for the information processing apparatus according to claim 4, wherein the information relevant to the image forming apparatus is a status about execution of a job of the image forming apparatus, and
wherein the change process changes the metadata based on a changed status in a case where it is determined that the status about the execution of the job has been changed based on the obtained information.

6. The control method for the information processing apparatus according to claim 4, wherein the information relevant to the image forming apparatus is information about available image forming apparatuses found by network retrieval, and
wherein the change process changes the metadata so as to include information for identifying a newly available image forming apparatus based on the obtained information in a case where the newly available image forming apparatus has been added.

7. The control method for the information processing apparatus according to claim 4, wherein the change process updates the display screen displayed on a display unit of the information processing apparatus and the information that should be read aloud by the voice guidance function by newly generating a display screen for newly displaying the information about the image forming apparatus and by changing the metadata associated with the new display screen.

8. The control method for the information processing apparatus according to claim 7, wherein the voice guidance is achieved by a screen reader that is provided by an operating system of the information processing apparatus, and
wherein the screen reader reads the metadata associated with the new display screen aloud in response to the change of the display on the display unit to the new display screen by the change process.

9. The control method for the information processing apparatus according to claim 8, wherein the screen reader reads the generated metadata in a case where the voice guidance function is effective in the information processing apparatus.
